(19) United States
(12) Patent Application Publication
(10) Pub. No.: US 2012/0262690 A1
(43) Pub. Date: Oct. 18, 2012

(54) ILLUMINATION SYSTEM, LITHOGRAPHIC APPARATUS AND ILLUMINATION METHOD

(75) Inventors: Wilhelmus Petrus De Boeij, Veldhoven (NL); Erik Roelof Loopstra, Eindhoven (NL); Uwe Mickan, Veldhoven (NL); Jan Bernard Plechelmus Van Schoot, Eindhoven (NL); Gosse Charles De Vries, Veldhoven (NL)

(73) Assignee: ASML Netherlands B.V., Veldhoven (NL)

(21) Appl. No.: 13/518,301

(22) PCT Filed: Nov. 29, 2010
(86) PCT No.: PCT/EP2010/068395

§ 371 Date: Jun. 21, 2012

Related U.S. Application Data
(60) Provisional application No. 61/290,533, filed on Dec. 29, 2009.

(51) Int. Cl. G03B 27/54

(52) U.S. Cl. 355/67

(57) ABSTRACT

An illumination system includes a field-facet mirror-device and a pupil mirror configured to condition a beam of radiation incident on the field-facet mirror-device. The field-facet mirror-device includes reflective field facets movable between first and second orientations relative to the incident beam. The field facets in their first orientations are effective to reflect the incident radiation towards respective reflective pupil facets so as to form part of a conditioned beam reflected from the pupil-facet mirror-device. The field facets in their second orientations are effective to reflect the incident radiation onto respective areas of the pupil-facet mirror-device designated as beam dump areas. The areas are arranged to prevent radiation incident on the areas from forming part of the conditioned beam and are arranged between the limits of an annular area on the pupil-facet mirror-device effective to define the inner and outer regions of the conditioned beam reflected from the pupil-facet mirror-device.

### CROSS-REFERENCE TO RELATED APPLICATIONS

This application claims the benefit of U.S. provisional application 61/290,533 which was filed on 29 Dec. 2009, and which is incorporated herein in its entirety by reference.

### FIELD

The present invention generally relates to a lithographic apparatus. The invention has particular application to an illumination system, which may form part of a lithographic apparatus and has particular, although not exclusive, application to an illumination system for adjusting the profile of a beam of extreme ultra violet (EUV) radiation in a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. A lithographic apparatus often includes an illumination system, which receives radiation from a source and produces an illumination beam for illuminating a patterning device. Such an illumination system typically includes an intensity distribution adjustment arrangement which directs, shapes and controls the intensity distribution of the beam. Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured. A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k1 is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k1.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm. It has further been proposed that EUV radiation with a wavelength of less than 10 nm could be used, for example within the range of 5-10 nm such as 6.7 nm or 6.8 nm. Possible EUV radiation sources include, for example, laser-produced plasma sources, discharge plasma sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created, for example, by directing a laser beam at a fuel, such as particles of a suitable material (e.g. tin), or a stream of a suitable gas or vapour, such as Xe gas or Li vapour. The resulting plasma emits radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

It is well known in the art of lithography that an image of the patterning device projected onto a substrate can be improved by appropriately choosing angles at which the patterning device is illuminated, i.e., by appropriately choosing an angular distribution of radiation illuminating the patterning device. In a lithographic apparatus having a Koehler illumination system, the angular distribution of radiation illuminating the patterning device is determined by a spatial intensity distribution of the illumination beam in a pupil plane of the illumination system. This is because the illumination beam at the pupil plane effectively acts as a secondary or virtual radiation source for producing the illumination beam that is incident on the patterning device. The shape of the spatial intensity distribution of the illumination beam at the pupil plane within the illumination system is commonly referred to as the illumination mode or profile.

Illumination beams with certain spatial intensity distributions at the pupil plane improve a processing latitude when an image of the patterning device is projected onto a substrate. In particular, an illumination beam having a spatial intensity distribution with a dipole, annular or quadrupole off-axis illumination mode may enhance the resolution and/or another characteristic of the projection process, such as a sensitivity to a projection system optical aberration, the exposure latitude and the depth of focus. Certain “soft-pole” illumination modes may also have an advantageous effect on the image of the patterning device projected onto a substrate. Accordingly, an illumination system typically includes one or more devices or structures to direct, shape and control the illumination beam such that it has a desired spatial intensity distribution (a desired illumination mode) at the pupil plane.

Particularly where EUV radiation is used, it is known to provide an illumination system including a field-facet mirror-device having a plurality of primary reflective facets. Hereinafter, these primary reflective elements may also be referred to as field facets. Each field facet receives, in use, an incident beam portion, i.e., a portion of the beam of EUV radiation emanating from the source collector module and incident on the field-facet mirror-device. The orientation of each field facet is controllable over a range of angles relative to the corresponding incident beam portion. Each field facet is effective to direct radiation from its incident beam portion onto a pupil-facet mirror-device having a plurality of secondary reflective facets. These secondary reflective elements may also be referred to as pupil facets. Each pupil facet will act, when irradiated, as a secondary light source for the patterning device such that the beam of EUV radiation incident on the patterning device may have a desired illumination mode.

An example of such an arrangement is shown in the U.S. Pat. No. 6,658,084 from which further information may be gleaned. This particular patent discloses an illumination system, including a field-facet mirror-device in which each field facet can be set at two possible orientations, the first and second orientations being such that either a corresponding first or a corresponding second pupil facet is irradiated. In such a system, there are twice as many pupil facets as there are field facets, and the corresponding first pupil facets define a first illumination mode while the corresponding second pupil facets define a second illumination mode. The radiation reflected from the first or second pupil facet forms part of the respective first or second illumination mode.

Such an arrangement may have the disadvantage that it is not possible to just modify the first illumination mode by having a field facet not irradiate its associated first pupil facet without having that field facet irradiate its associated second pupil facet. Similarly, one may not modify the second illumination mode by having the field facet not irradiate the second pupil facet without having it irradiate the first pupil facet.

### SUMMARY OF THE INVENTION

It is an aspect of the present invention to alleviate above-mentioned potential disadvantages by enabling illumination mode adjustments per pupil facet.

According to an aspect of the invention, there is provided an illumination system for use in a lithographic apparatus arranged to project a pattern of a patterning device on a substrate using a projection system. The illumination system includes a field-facet mirror-device, and a pupil-facet mirror-device. The field-facet mirror-device includes a plurality of reflective field facets, each field facet being switchable between a first orientation in which an incident extreme ultra violet radiation beam portion traversing the field facet is directed to the pupil-facet mirror-device and from there to the patterning device, and a supplementary orientation in which the beam portion is directed onto an area of the pupil-facet mirror-device disposed within a radial extent corresponding to the numerical aperture of the projection system of the lithographic apparatus, and arranged as a beam dump area effective to collect incident radiation and to avoid that radiation from reaching the patterning device.

According to an aspect of the invention, there is provided a lithographic apparatus that includes an illumination system that includes a field-facet mirror-device and a pupil-facet mirror-device. The lithographic apparatus also includes a support configured to support a patterning device. The patterning device is configured to receive radiation from the illumination system and pattern the radiation. The lithographic apparatus also includes a projection system configured to project the patterned radiation on a substrate. The field-facet mirror-device includes a plurality of reflective field facets, each field facet being switchable between a first orientation in which an incident extreme ultra violet radiation beam portion traversing the field facet is directed to the pupil-facet mirror-device and from there to the patterning device, and a supplementary orientation in which said beam portion is directed onto an area of the pupil-facet mirror-device disposed within a radial extent corresponding to the numerical aperture of the projection system, and arranged as a beam dump area effective to collect incident radiation and to avoid that radiation from reaching the patterning device.

According to an aspect of the invention, there is provided a method for modifying an illumination mode provided by an illumination system of a lithographic apparatus. The illumination system includes a field-facet mirror-device and a pupil-facet mirror-device. The field-facet mirror-device includes a plurality of reflective field facets. The method includes directing a beam of radiation to the field-facet mirror-device, and switching a field facet from a first orientation in which an incident extreme ultra violet radiation beam portion traversing the field facet is directed to the pupil-facet mirror-device and from there to a patterning device of the lithographic apparatus, to contribute to generating the illumination mode, to a supplementary orientation in which said beam portion is directed onto an area of the pupil-facet mirror-device disposed within a radial extent corresponding to the numerical aperture of a projection system of the lithographic apparatus, and arranged as a beam dump area effective to collect incident radiation and to avoid that radiation from reaching the patterning device.

According to an aspect of the invention, there is provided a device manufacturing method that includes modifying an illumination mode provided by an illumination system of a lithographic apparatus. The illumination system includes a field-facet mirror-device and a pupil-facet mirror-device. The field-facet mirror-device includes a plurality of reflective field facets. The modifying includes directing a beam of radiation to the field-facet mirror-device; and switching a field facet from a first orientation in which an incident extreme ultra violet radiation beam portion traversing the field facet is directed to the pupil-facet mirror-device and from there to a patterning device of the lithographic apparatus, to contribute to generating the illumination mode, to a supplementary orientation in which said beam portion is directed onto an area of the pupil-facet mirror-device disposed within a radial extent corresponding to the numerical aperture of a projection system of the lithographic apparatus, and arranged as a beam dump area effective to collect incident radiation and to avoid that radiation from reaching the patterning device. The device manufacturing method also includes patterning radiation received from the illumination system with the patterning device, and projecting the patterned radiation onto a substrate with the projection system.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 is a more detailed view of the apparatus of FIG. 1, including a DPP source collector module;

FIG. 3 is a view of an alternative source collector module of the apparatus of FIG. 1, the alternative being an LPP source collector module;

FIG. 4 is a more detailed view of an illumination system of FIG. 2;

FIG. 5 is a schematic explanatory diagram depicting the operation of an example of a field-facet mirror-device for use in an illumination system which is not in accordance with the invention;

FIG. 6 is a schematic explanatory diagram depicting the operation of the field-facet mirror-device for use in an illumination system according to an embodiment of the invention;

FIG. 7 illustrates the beam profile of the beam facetted pupil-facet mirror-device of FIG. 6 in an illumination system according to an embodiment of the invention;

FIG. 8 illustrates the beam profile produced by the pupil-facet mirror-device of FIG. 6 in an illumination system according to an embodiment of the invention; and

FIG. 9 illustrates beam profile produced by the pupil-facet mirror-device of FIG. 6 in an illumination system according to an embodiment of the invention.

### DETAILED DESCRIPTION

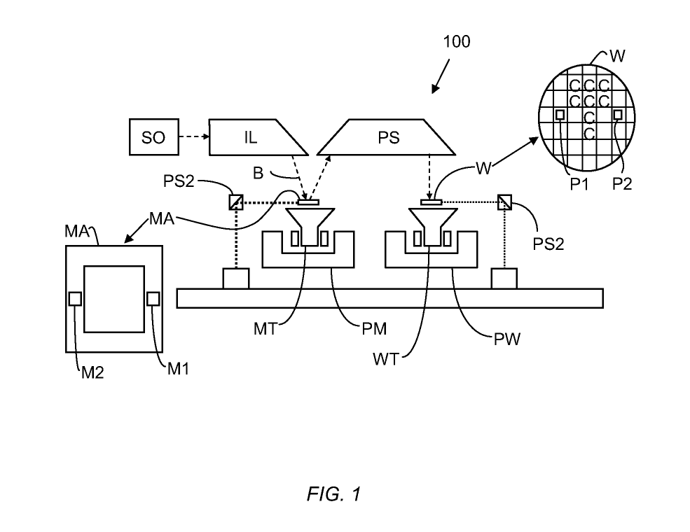

FIG. 1 schematically depicts a lithographic apparatus 100 including a source collector module SO according to one embodiment of the invention. The apparatus comprises: an illumination system (illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device; a substrate table (e.g. a wafer table) WT constructed to hold a substrate (e.g. a resist-coated wafer) W and connected to a second positioner PW configured to accurately position the substrate; and a projection system (e.g. a reflective projection system) PS configured to project a pattern imparted to the radiation beam B by patterning device MA onto a target portion C (e.g. comprising one or more dies) of the substrate W.

The illumination system may include reflective, diffractive or refractive components, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illuminator IL may be used to condition the radiation beam incident on the patterning device to have a both a desired intensity uniformity and a desired angular intensity distribution in its cross-section. The illuminator IL may include a field-facet mirror-device having a plurality of reflective field facets and a pupil-facet mirror-device having a plurality of reflective pupil facets. Each of the field facets receives, in use, an incident beam portion being a portion of a beam of incident EUV radiation emanating from the source collector module SO. An illumination-mode selection-system may be constructed and arranged to set a desired illumination mode. For example, each of the field facets may be oriented to reflect EUV radiation to corresponding, different pupil facets belonging to a first group of the reflective pupil facets defining a first illumination mode, or alternatively may be oriented to reflect EUV radiation to corresponding, different pupil facets belonging to a second group of the reflective pupil facets defining a second illumination mode. The selection of an illumination mode is obtained by adjusting an angular intensity distribution of the radiation beam incident on the patterning device MA through adjusting a corresponding spatial intensity distribution of radiation as reflected by the pupil facets and directed towards the patterning device.

The radiation beam B is incident on the patterning device (e.g., mask) MA, which is held on the support structure (e.g., mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.
2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-) magnification and image reversal characteristics of the projection system PS.
3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

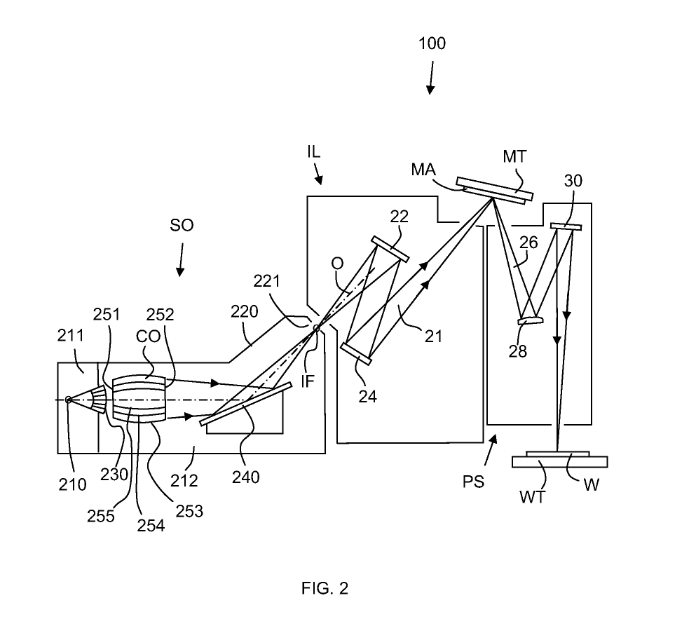

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma source. EUV radiation may be produced by a gas or vapor, for example Xe gas, Li vapor or Sn vapor in which the very hot plasma 210 is created to emit radiation in the EUV range of the electromagnetic spectrum. The very hot plasma 210 is created by, for example, an electrical discharge causing an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 212 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF is commonly referred to as the intermediate focus, and the source collector module is arranged such that the intermediate focus IF is located at or near an opening 219 in the enclosing structure 220. The virtual source point IF is an image of the radiation emitting plasma 210.

Subsequently, the radiation traverses the illumination system IL, which includes a field-facet mirror-device 22 and a pupil-facet mirror-device 24 arranged to provide a desired angular intensity distribution of the radiation beam 21 at the patterning device MA, as well as a desired uniformity of radiation intensity at the patterning device MA. As explained above a selection of an illumination mode is obtained by optically connecting the field facets (through appropriately orientating the field facets) to a group of corresponding, different pupil facets. The irradiated pupil facets serve as a secondary light source having the desired spatial intensity distribution defining the illumination mode. For example, the group of corresponding, different pupil facets may be chosen to define one or more off axis, bright poles for providing a polar, off axis illumination mode. Alternatively, the group may be chosen to define an annular illumination mode or a conventional illumination mode. For example, an outer radial extent of the intensity distribution in a pupil plane of the illuminator, at or near the pupil facets, can be selected. The outer radial extent is denoted by σ-outer, where σ-outer is defined as the selected outer radial extent divided by an outer radial extent which matches the numerical aperture NA of the projection system. Similarly, an inner radial extent of the intensity distribution, denoted by σ-inner, can be selected. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown may generally be present in illumination optics unit IL and projection system PS. The grating spectral filter 240 may optionally be present, depending upon the type of lithographic apparatus. Further, there may be more mirrors present than those shown in the Figures. For example, the projection system PS may actually include 6 or 8 reflective elements.

Collector optic CO, as illustrated in FIG. 2, is depicted as a nested collector with grazing incidence reflectors 253, 254 and 255, just as an example of a collector (or collector mirror). The grazing incidence reflectors 253, 254 and 255 are disposed axially symmetric around an optical axis O and a collector optic CO of this type is desirably used in combination with a discharge produced plasma source, often called a DPP source.

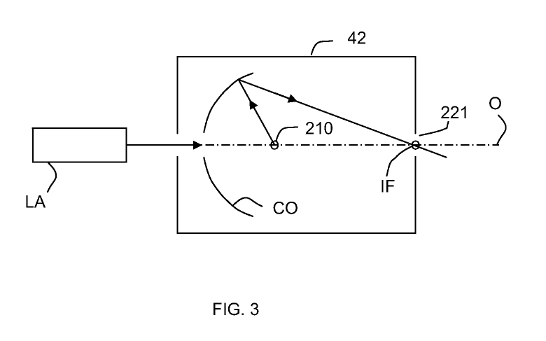

Alternatively, the source collector module SO may be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10s of eV. The energetic radiation generated during de-excitation and recombination of these ions is emitted from the plasma, collected by a near normal incidence collector optic CO and focused onto the opening 221 in the enclosing structure 220.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

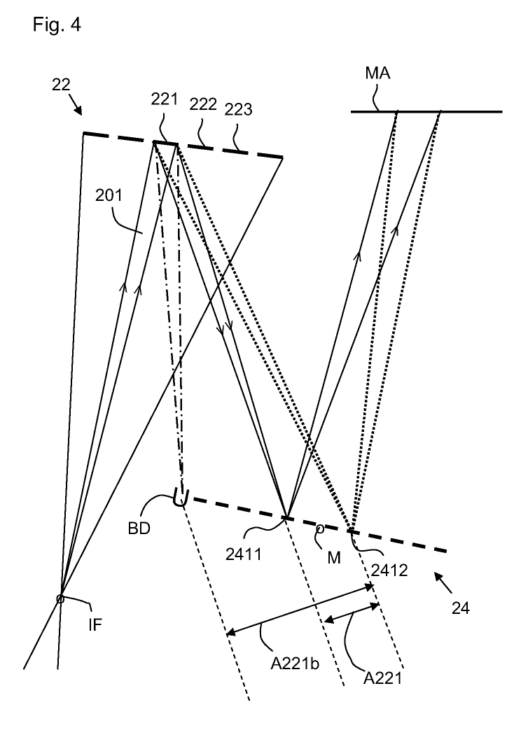

Referring now to FIG. 4, this Figure shows the field-facet mirror-device 22 and the pupil-facet mirror-device 24 in more detail. The pupil-facet mirror-device may be disposed at or near a pupil plane of the illumination system IL, and its center M may be arranged coincident with the optical axis O of the radiation system, as shown in FIG. 2. In embodiments of the invention to be described, the reflective field facets such as field facets 221, 222, 223 are tri state devices in that they each have three possible orientations relative to respective incident beam portions of EUV radiation. The first two orientations are effective to reflect the incident beam portions onto respective first and second pupil facets. These first and second pupil facets are part of respective first and second groups of pupil facets. The third orientation is effective to reflect the incident beam portion into a position in which it does not contribute to the beam incident on the patterning device MA, and hence in which it does not contribute to a selected illumination mode. Thus in FIG. 4, by way of example, reflective field facet 221 is shown as reflecting the incident beam portion 201 onto either reflective pupil facet 211 as indicated in the full line ray path, or reflective pupil facet 2412 of the pupil-facet mirror-device 24 as indicated by the dotted line ray path. In a third orientation field facet 221 reflects the incoming beam portion 201 to a position away from the pupil-facet mirror-device 24, the reflected light being shown by the hashed line. The latter reflected light is to be absorbed by a beam dump area BD on the wall of the illumination system IL. An activation system (not shown) which may be part of the illumination-mode selection-system is provided to enable the orientation of each of the reflective field facets to be set dependent on the required illumination configuration of the beam. The double arrow A221 schematically indicates a magnitude of an angular tilt range of the field facet 221 used for switching between the two illumination modes. An angular range A221b would be needed to reflect the incident beam portion 201 to a position away from the pupil-facet mirror-device. The angular range A221b differs from the range A221 and is generally larger than the range A221.

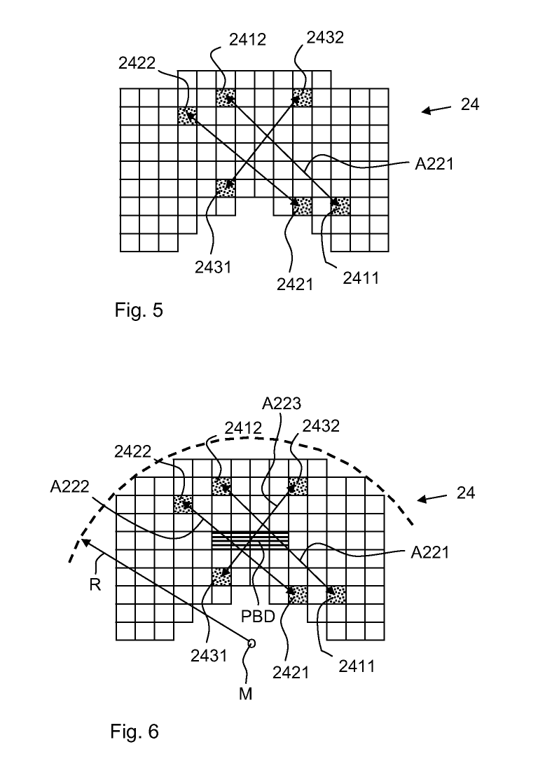

FIG. 5 illustrates a top view of a sector of the pupil-facet mirror-device 24. As explained above, each field facet of the field-facet mirror-device 22 can illuminate two associated pupil facets, one at a time, depending of the orientation of the particular field facet. Three such pairs of associated pupil facets (2411, 2412), (2421, 2422), and (2431, 2432) are shown in FIG. 5, each pupil facet being depicted by dotted shading, with each pair of associated pupil facets being shown connected by a respective double arrow.

It will be appreciated that as each field facet of the field-facet mirror-device is able to direct incident radiation onto two pupil facets of the pupil-facet mirror-device, the pupil-facet mirror-device will have twice the number of facets compared to the number of field facets. Furthermore, while in FIG. 4 only a few field facets have been shown in the field-facet mirror-device 22, the field-facet mirror-device may include for example an array of 32×32 field facets, or any suitable number of field facets.

It will be appreciated that in the illumination system described in relation to FIGS. 4 and 5, the radiation reflected by the field-facet mirror-device 22 to a beam dump area BD away from the pupil-facet mirror-device 24 must be deflected by field facets of the field-facet mirror-device 22 by an angle different from angles at which the reflected radiation is to form part of an illumination mode. Field facet 221 may be rotatable about an axis perpendicular to the double arrow A221 in FIG. 5, so that an additional, further rotation about this axis would be needed to reflect the incident beam portion to a beam dump BD as shown in FIG. 4, with the effect that the total rotation range A221b, as shown in FIG. 4, is generally larger that the range A221. The magnitude of a desired tilt range of a field facet determines a required free space between the field facet and its neighboring field facets. The free space reduces a spatially integrated reflectance of the field-facet mirror-device relative to a situation where the neighboring field facets are in close contact. For example, a field facet may have a thickness of 3 mm (along an axis perpendicular to its reflective surface), and the tilt range A221b in FIG. 4 may be 100 mrad. In this example, the desired free space would be 0.3 mm. If the neighboring field facet is rotatable as well over a similar range, a free space between the two field facets may need to be 0.6 mm not including any other manufacturing or system tolerances. This may reduce above mentioned integrated reflectance by a few percentage. It is desirable to mitigate such an effect of loss of EUV radiation.

According to an embodiment of the present invention, there is provided an illuminator system for use in a lithographic apparatus, including a field-facet mirror-device including a plurality of reflective field facets, each field facet being switchable between an orientation in which an incident radiation beam portion traversing a field facet is directed to a pupil-facet mirror-device effective to direct radiation from the field-facet mirror-device onto a patterning device and an orientation in which said beam portion is directed onto an area of the pupil-facet mirror-device disposed within a radial extent corresponding to the numerical aperture of a projection system of the lithographic apparatus and arranged as a beam dump area effective to collect incident radiation and to avoid it from reaching the patterning device. The latter radiation is therefore not part of any illumination mode.

FIG. 6 illustrates further aspects of this embodiment. Between a pair of associated pupil facets such as the pair of pupil facets (2411, 2412), shown connected by the double arrow A221 in this Figure, there is provided a pupil area PBD arranged as a beam dump area such that EUV radiation traversing the area PBD or incident on this area does not contribute to the beam incident on the patterning device MA. The area PBD is disposed within a radial extent of the pupil-facet mirror-device with respect to its center M. The extent has a radius R corresponding to σ=1, hence the radial extent R corresponds to the numerical aperture of the projection system of the lithographic apparatus. This radial extent is denoted by the circular dashed line in FIG. 6. The beam dump area PBD may be made of an absorbing material. Alternatively the beam dump area may be arranged to reflect the incident radiation to a beam dump area (not shown) located away from the pupil-facet mirror-device, where EUV radiation absorbent material is provided.

In FIG. 6, the beam dump area PBD is shown as a linear arrangement of four pupil facet like areas. The beam dump area PBD is positioned so as part of it lies on the lines connecting each of the pairs of associated pupil facets (2411, 2412), (2421, 2422) and (2431, 2432). As a consequence, tilt ranges A221, A222, and A223 of respective field facets 221, 222 and 223 now each include a tilt at which the radiation reflected by the respective field facet does not contribute to any illumination mode, while the magnitude of the tilt range is determined by the pair of selectable illumination modes. Hence the magnitude of a field-facet tilt-range no longer exceeds the latter illumination-mode related magnitude, which in turn reduces needed free space between adjacent field facets. It will be appreciated that while in FIGS. 5 and 6 only three pairs of pupil facets are shown, in practice the pairs of associated pupil facets may be distributed all over the pupil-facet mirror-device 24, the location of the beam dump area PBD on the pupil-facet mirror-device 24 being chosen in view of the particular required illumination mode, as will now be explained.

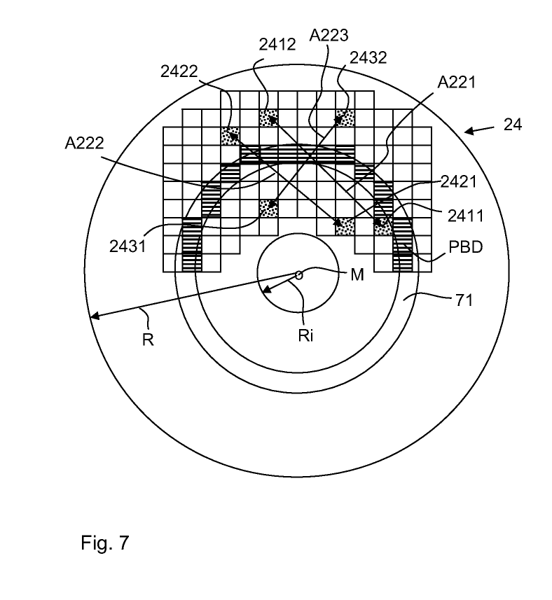

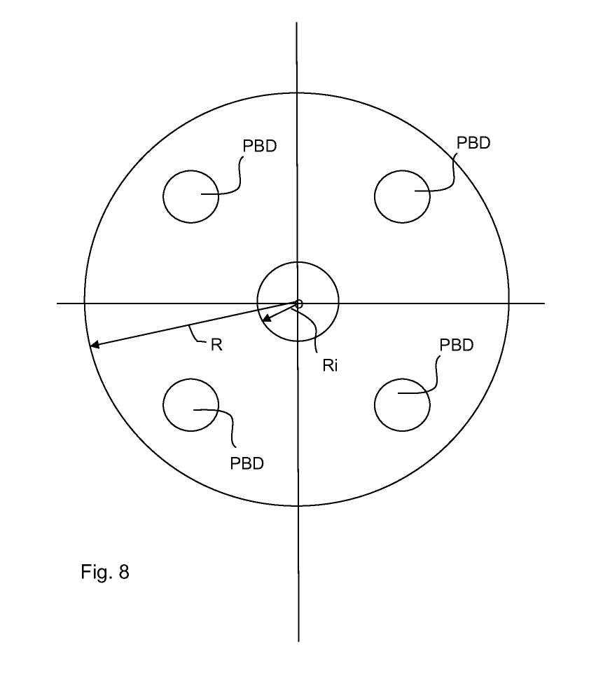

FIG. 7 illustrates a top view of an example of a beam dump area PBD on the pupil-facet mirror-device 24 where the beam dump area is arranged in a substantially annular shape, matching an annular area 71. For simplicity, only a section of the pupil facets and the beam dump area PBD is shown in detail. The beam dump area is formed as an annular ring of facet like beam dump areas on the pupil-facet mirror-device 24 so as to form a substantially annular ring 71 lying between the outer radial extent R and an inner radial extent Ri. The outer perimeter R corresponds, as in FIG. 6, to the numerical aperture NA of the optical projection system PS of the apparatus 100. A potential advantage of such an annular beam dump area is that it can be used in assignment schemes for defining pupil facet pairs wherein one pupil facet of a pair is chosen within a selected radial extent between R and Ri, and the other pupil facet of the pair is chosen outside that selected radial extent. Such assignment schemes are suitable for supporting groups of selectable illumination modes including, for example, an annular illumination mode and an off-axis multipole illumination mode. The angular tilt range associated with each pair then includes a tilt at which the corresponding field facet can be set in an “off state”, i.e., a state for use to modify an illumination mode by excluding a pupil facet from contributing to that illumination mode. Thus, in an illumination system in accordance with an embodiment of the invention, for field facets which are in an “off” state corresponding to a particular configuration of the illumination beam, or for any defective field facets which can occur in the field-facet mirror-device, unwanted radiation can be directed to the beam dump PBD on the pupil-facet mirror-device 24 at a field facet tilt well within the maximum angle range of the field facet mirrors. Due to the reduced tilt angle range, elongated field facets 221, 222, 223, etc., (having a shape in accordance with an illumination slit at the mask MA) can be made stiffer by applying a large facet thickness, making different material choices such as silicon possible for manufacture of the mirror facets.

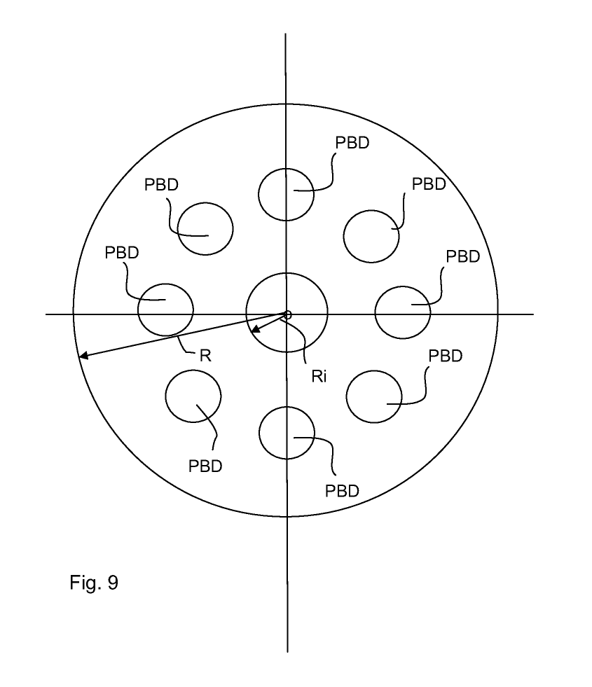

It should be appreciated that other configurations of beam dump areas PBD using the pupil-facet mirror-device can be provided. FIG. 8 illustrates a pupil-facet mirror-device 24 including four polar beam dump areas PBD. Each beam dump area PBD is disposed within the radius R with σ=1. It is found that using four such beam dump areas on the pupil-facet mirror-device, a maximum tilt-angle range for field facets can be limited to 70% of the tilt-angle range for an arrangement in which a beam dump area is situated outside, in the periphery of the pupil-facet mirror-device.

Turning now to FIG. 9, this Figure illustrates an arrangement in which eight beam dump areas PBD are arranged between R and Ri due to appropriate pupil facet like areas on the pupil-facet mirror-device 24 being arranged to act as beam dump, or to direct incident EUV radiation to an external beam dump area (not shown). In such a case the tilt-angle range of the corresponding field facets on the field-facet mirror-device 22 can be limited to 50% of the tilt-angle range for an arrangement in which radiation must be directed outside the perimeter of the pupil-facet mirror-device 24.

It will be appreciated that while it may be advantageous to have the beam dump region between radial extents R and Ri as shown in the arrangements of FIGS. 7, 8 and 9, it is possible in accordance with the invention to arrange for an additional beam dump area to be at the edge of the pupil-facet mirror-device 24, as shown in FIG. 4. While the range over which the field facets of the field-facet mirror-device 22 must be tiltable is not reduced by as much as in the other embodiments, there is still an advantage over the prior art, that by using the outer perimeter of the pupil-facet mirror-device as part of the beam dump arrangement for some of the field facets, it is not necessary for all of the field facets of the field-facet mirror-device 22 to be tiltable so as to direct radiation outside the perimeter of the pupil-facet mirror-device 24.

It will be appreciated that while the invention has particular application in a lithographic apparatus employing EUV radiation, the invention has also application in a lithographic apparatus having radiation within other wavelength bands.

It will also be appreciated that while in the particular embodiments described before, the facets of the field-facet mirror-device are three state devices, having three possible orientations, the invention is also applicable to field facet mirrors having two states, one of which corresponds to a facet orientation in which the incident radiation is directed into the beam incident on the patterning device MA, and one state corresponding to an orientation in which the beam is directed to a pupil facet like area arranged as a beam dump area on the pupil-facet mirror-device. Similarly the invention is applicable to field facet mirrors positionable at four, five or even more tilts with respect to an incident beam portion.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein. The descriptions above are intended to be illustrative, not limiting. Thus it will be apparent to one skilled in the art that modifications may be made to the invention as described without departing from the scope of the claims set out below.

1. An illumination system for use in a lithographic apparatus arranged to project a pattern of a patterning device on a substrate using a projection system, the illumination system comprising:
a field-facet mirror-device; and
a pupil-facet mirror-device,
the field-facet mirror-device comprising a plurality of reflective field facets, each field facet being switchable between
a first orientation in which an incident extreme ultra violet radiation beam portion traversing the field facet is directed to the pupil-facet mirror-device and from there to the patterning device, and
a supplementary orientation in which said beam portion is directed onto an area of the pupil-facet mirror-device disposed within a radial extent corresponding to the numerical aperture of the projection system of the lithographic apparatus, and arranged as a beam dump area effective to collect incident radiation and to avoid that radiation from reaching the patterning device.

2. An illumination system according to claim 1, wherein each field facet is additionally switchable to
a second orientation in which an incident extreme ultra violet radiation beam portion traversing the field facet is directed to the pupil-facet mirror-device and from there to the patterning device.

3. An illumination system according to claim 1, wherein the beam dump area includes an isolated area eccentric with respect to a center of the pupil-facet mirror-device, the center being defined by an optical axis of the illumination system.

4. An illumination system according to claim 1, wherein the beam dump area includes an annular area centered with respect to a center of the pupil-facet mirror-device, the center being defined by an optical axis of the illumination system.

5. An illumination system according to claim 1, wherein the beam dump area is configured to absorb incident radiation.

6. An illumination system according to claim 1, wherein the beam dump area is associated with a device arranged to absorb radiation and disposed remote from the pupil-facet mirror-device, and wherein the beam dump area is arranged to reflect incident radiation onto the associated radiation absorbing device.

7. A lithographic apparatus comprising:
an illumination system comprising a field-facet mirror-device and a pupil-facet mirror-device;
a support configured to support a patterning device, the patterning device being configured to receive radiation from the illumination system and pattern the radiation; and
a projection system configured to project the patterned radiation on a substrate,
the field-facet mirror-device comprising a plurality of reflective field facets, each field facet being switchable between
a first orientation in which an incident extreme ultra violet radiation beam portion traversing the field facet is directed to the pupil-facet mirror-device and from there to the patterning device, and
a supplementary orientation in which said beam portion is directed onto an area of the pupil-facet mirror-device disposed within a radial extent corresponding to the numerical aperture of the projection system, and arranged as a beam dump area effective to collect incident radiation and to avoid that radiation from reaching the patterning device.

8. A method for modifying an illumination mode provided by an illumination system of a lithographic apparatus, the illumination system comprising a field-facet mirror-device and a pupil-facet mirror-device, the field-facet mirror-device comprising a plurality of reflective field facets, the method comprising:
directing a beam of radiation to the field-facet mirror-device; and
switching a field facet from a first orientation in which an incident extreme ultra violet radiation beam portion traversing the field facet is directed to the pupil-facet mirror-device and from there to a patterning device of the lithographic apparatus, to contribute to generating the illumination mode, to a supplementary orientation in which said beam portion is directed onto an area of the pupil-facet mirror-device disposed within a radial extent corresponding to the numerical aperture of a projection system of the lithographic apparatus, and arranged as a beam dump area effective to collect incident radiation and to avoid that radiation from reaching the patterning device.

9. A device manufacturing method comprising:
modifying an illumination mode provided by an illumination system of a lithographic apparatus, the illumination system comprising a field-facet mirror-device and a pupil-facet mirror-device, the field-facet mirror-device comprising a plurality of reflective field facets, the modifying comprising
directing a beam of radiation to the field-facet mirror-device; and
switching a field facet from a first orientation in which an incident extreme ultra violet radiation beam portion traversing the field facet is directed to the pupil-facet mirror-device and from there to a patterning device of the lithographic apparatus, to contribute to generating the illumination mode, to a supplementary orientation in which said beam portion is directed onto an area of the pupil-facet mirror-device disposed within a radial extent corresponding to the numerical aperture of a projection system of the lithographic apparatus, and arranged as a beam dump area effective to collect incident radiation and to avoid that radiation from reaching the patterning device;
patterning radiation received from the illumination system with the patterning device; and
projecting the patterned radiation onto a substrate with the projection system.
